(19) United States
(12) Patent Application Publication
(10) Pub. No.: US 2026/0097898 A1
(43) Pub. Date: Apr. 9, 2026

(54) STORAGE SYSTEM AND STORAGE CONTAINER

(71) Applicant: Ocado Innovation Limited, Hatfield (GB)

(72) Inventors: Lars Sverker Ture LINDBO, Stockholm (SE); Johan Törnell, Billdal (SE)

(21) Appl. No.: 19/351,919

(22) Filed: Oct. 7, 2025

Related U.S. Application Data
(63) Continuation of application No. PCT/EP2024/059706, filed on Apr. 10, 2024.

(30) Foreign Application Priority Data
Apr. 12, 2023 (GB) 2305337.4

(51) Int. Cl. B65G 1/04

(52) U.S. Cl. CPC B65G 1/0478; B65G 1/0464

(57) ABSTRACT

A storage container is provided for the storage of one or more items in a storage and retrieval system. The storage container comprises a metallic container body comprising a bottom wall and sidewalls and end walls arranged in a box-like structure having an open end for receiving the one or more items within the box-like structure. The metal container body is formed from two sheet metal blanks, each of the two sheet metal blanks comprising a base portion and outwardly extending panel portions, the outwardly extending panel portions of each of the two sheet metal blanks being folded along respective fold lines relative to the base portion forming the sidewalls and end walls. The two sheet metal blanks are arranged such that the base portion of each of the two sheet metal blanks overlap to form a double layered bottom wall and single walled side walls and end walls.

### TECHNICAL FIELD

The present invention relates to the field of storage systems comprising load handling devices operative on tracks located on a grid framework structure for handling storage containers stacked in the grid framework structure, and storage containers for use in such storage systems.

### BACKGROUND

Some commercial and industrial activities require systems that enable the storage and retrieval of a large number of different products. One known type of system for the storage and retrieval of items in multiple product lines involves arranging storage containers (also known as bins or totes) in stacks on top of one another, the stacks being arranged in rows. The storage containers are removed from the stacks and accessed from above by load handling devices, removing the need for aisles between the rows and thereby allowing a large number of containers to be stored in a given space.

As shown in FIGS. 1 and 2, storage containers 10, also known as bins or totes, are stacked on top of one another to form stacks 12. The stacks 12 are arranged in a grid framework structure 14 in a warehousing or manufacturing environment. The grid framework is made up of a plurality of storage columns or grid columns. Each grid in the grid framework structure has at least one grid column for storage of a stack 12 of containers 10. FIG. 1 is a schematic perspective view of the grid framework structure 14, and FIG. 2 is a top-down view showing a single stack 12 of containers 10 arranged within the grid framework structure 14. Each container or bin 10 typically holds a plurality of product items (not shown), and the product items within a container 10 may be identical, or may be of different product types depending on the application. Each container 10 may be used to store grocery items (i.e. food items), for example. Furthermore, the bins 10 may be physically subdivided to accommodate a plurality of different inventory items.

In the description below, bins 10 will be used to denote the storage containers intended for the storage of inventory items, whilst delivery containers DT will be used to denote containers filled or intended to be filled to fulfil customer orders placed by customers. It will be appreciated that this terminology is used for ease of reference and explanation within this document. However, it should be noted that the bins 10 and the containers DT may be of the same shape and configuration. Furthermore, delivery containers DT may be stored in bins 10 within the storage system or any part thereof.

The grid framework structure 14 comprises a plurality of upright members or upright columns 16 that support horizontal grid members 18, 20. A first set of parallel horizontal grid members 18 is arranged perpendicularly to a second set of parallel horizontal grid members 20 to form a track system 15 comprising a plurality of grid cells extending in a substantially horizontal plane and supported by the upright members 16. The members 16, 18, 20 are typically manufactured from metal and typically welded or bolted together or a combination of both. The containers 10 are stacked between the members 16, 18, 20 of the grid framework structure 14, so that the grid framework structure 14 guards against horizontal movement of the stacks 12 of containers 10, and guides vertical movement of the containers 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

Each load handling device 30 comprises a vehicle body 32 which is arranged to travel in the X and Y directions on the tracks or rails 22 of the grid frame structure 14, above the stacks 12 (see FIG. 4). FIGS. 4 and 5 shows a load handling device 30 according to an embodiment of the present invention and described in PCT Patent Publication No. WO2015/019055 (Ocado Innovation Limited) and international patent application WO2015/185628A describes a storage and fulfilment system in which stacks of storage containers are arranged within a grid framework structure. The containers are accessed by load handling devices operative on tracks located on the top of the grid framework structure.

The load handling device 30 comprises a vehicle body 32 equipped with a lifting mechanism 33 (see FIG. 4) comprising a winch or a crane mechanism 35 to lift a storage container or bin 10, also known as a tote, from above. The crane mechanism 35 comprises a winch cable 38 wound on a spool or reel and a grabber device 39. Typically, the lifting device comprises a set of lifting tethers 38 extending in a vertical direction and connected nearby or at the four corners of the grabber device 39 (one tether near each of the four corners of the grabber device) for releasable connection to a storage container 10. The grabber device 39 is configured to grip the top of the storage container 10 and lift it from a stack of containers in a storage system of the type shown in FIGS. 1 and 2. Typically, the grabber device 39 is configured as a lifting frame. Further details of the grabber device is discussed below.

The vehicle body 32 comprises an upper part and a lower part (see FIGS. 5A and 5B). The lower part is fitted with two sets of wheels 34, 36, which run on rails at the top of the framework structure of the storage system. The upper part of the vehicle body 32 may house a majority of the bulky components of the load handling device. Typically, the upper part of the vehicle body houses a driving mechanism for driving both the wheels and the lifting mechanism together with an on-board rechargeable power source for providing the power to the driving mechanism and the lifting mechanism.

The lower part of the vehicle body 32 comprises a wheel assembly that is are driven to enable movement of the vehicle in X and Y directions respectively along the rails. A first set of wheels 34, consisting of a pair of wheels 34 on the front of the vehicle 32 and a pair of wheels 34 on the back of the vehicle 32, are arranged to engage with two adjacent rails of the first set 22a of rails 22. Similarly, a second set of wheels 36, consisting of a pair of wheels 36 on each side of the vehicle 32, are arranged to engage with two adjacent rails of the second set 22b of rails 22. One or both sets of wheels can be moved vertically to lift each set of wheels clear of the respective rails, thereby allowing the vehicle to move in the desired direction. When the first set of wheels 34 is engaged with the first set of tracks or rails 22a and the second set of wheels 36 are lifted clear from the tracks or rails 22, the wheels 34 can be driven, by way of a drive mechanism (not shown) housed in the vehicle 32, to move the load handling device 30 in the X direction. To move the load handling device 30 in the Y direction, the first set of wheels 34 are lifted clear of the tracks or rails 22, and the second set of wheels 36 are lowered into engagement with the second set of tracks or rails 22a. The drive mechanism can then be used to drive the second set of wheels 36 to achieve movement in the Y direction. One or both sets of wheels can be moved vertically to lift each set of wheels clear of the respective rails, thereby allowing the vehicle to move in the desired direction on the track system.

The wheels are arranged around the periphery of a cavity or recess, known as a container-receiving recess 40, in the lower part. The recess 40 is sized to accommodate the storage container or bin 10 when it is lifted by the crane mechanism, as shown in FIGS. 5A and 5B. When in the recess, the container is lifted clear of the rails beneath, so that the load handling device can move laterally to a different location. On reaching the target location, for example another stack, an access point in the storage system or a conveyor belt, the bin or storage container can be lowered from the container receiving space and released from the grabber device 39. In this way, one or more robotic load handling devices 30 can move around the top surface of the stacks 12 on the frame structure 14, as shown in FIG. 3 under the control of a centralised control utility (not shown). Each robotic load handling device 30 is provided with a lifting mechanism 38 for lifting one or more bins 10 from the stack 12 to access the required items stored therein.

The body of the vehicle 32 can comprise the container receiving space 40 in the form of a cavity for accommodating a bin 10 (see FIGS. 5A and 5B). The cavity 40 being of a size capable of holding a bin or storage container 10. The lifting mechanism comprising a set of lifting tethers 38 extending in a vertical direction are connected at the four corners of a lifting frame (not shown), otherwise known as the grabber device (one tether near each of the four corners of the grabber device) for releasable connection to a storage container. The grabber device is configured to releasably grip the top of a storage container to lift it from a stack of containers in a storage system of the type shown in FIGS. 1 and 3. The lifting mechanism lifts a bin 10 from the stack 12 to within the cavity 40 within the body of the vehicle 32. Whilst the container receiving space 40 for accommodating a bin 10 when it is lifted by the winch means is arranged within the vehicle body 32 shown in FIG. 4, the present invention is not limited to the container receiving space 40 being located within the vehicle body 32. The present invention is also applicable to the container receiving space being located below a cantilever such as in the case where the vehicle body of the load handling device has a cantilever construction as described in WO2019/238702 (Autostore Technology AS). For the purpose of the invention, the term ‘vehicle body“ is construed to optionally cover a cantilever such that the grabber device is located below the cantilever. However, for ease of explanation of the present invention, the container receiving space for receiving a container is arranged within a cavity or recess within the vehicle body. The container receiving space allows multiple products to be accessed from multiple locations in the grid and stacks at any one time.

The robotic load handling devices 30 remove bins 10 containing inventory items (not shown) therein and transport the bins 10 to pick stations (not shown) where the required inventory items 28 are removed from the bins 10 and placed into bins 10 comprising delivery containers DT. It is important to note that a delivery container DT may fit within a bin 10. The bins 10 may comprise inventory items or may comprise delivery containers DT. Furthermore, the delivery containers DT may comprise at least one bag, the inventory items being picked directly into a bag at a pick station (not shown).

The empty bins 10 or the bins comprising delivery containers DT or the bins comprising delivery containers DT and bags may all be stored within the stacks 12. It will be appreciated that all the bins 10 have substantially the same external shape and configuration.

FIG. 3 shows a typical storage and retrieval system 1 as described above, the system having a plurality of load handling devices 30 active on the grid above the stacks 12. FIGS. 1 and 3 show the bins 10 in stacks 12 within the storage system. It will be appreciated that there may be a large number of storage containers or bins 10 in any given storage system and that many different items may be stored in the bins 10 in the stacks 12, each bin 10 may contain different categories of inventory items within a single stack 12.

In one storage and retrieval system described above and further in UK Patent Application Number GB1410441.8 (Ocado Innovation Limited), hereby incorporated by reference, the storage and retrieval system comprises a series of bins 10 that may further comprise delivery containers DT with customer orders contained therein or may further comprise bins 10 with inventory items awaiting picking contained therein. These different bins 10 and combinations thereof may be contained in the storage system and be accessed by the robotic load handling devices 30 as described above.

The storage containers in such storage systems are typically made of a thermoplastic material and may be formed by injection moulding or blow moulding, for example. Examples of thermoplastic materials include polypropylene, polyethylene (e.g. high density polyethylene (HDPE)), acrylonitrile butadiene styrene (ABS) and polycarbonate.

A problem with using thermoplastic storage containers in the storage systems described above is that they can be highly flammable and emit toxic fumes, and given that the storage system may contain hundreds or thousands of storage containers, the storage containers pose a significant risk in the event of a fire. To overcome the issue of the flammability of the storage containers, there has been a move towards the use of metal in the fabrication of the storage container. In comparison to thermoplastic material, the use of metal in the fabrication of the storage containers allows the storage containers to withstand much higher temperatures before disintegrating and emit very little or no toxic fumes in an event of a fire.

WO2022161863 (Autostore Tech AS) teaches a storage container for an automated storage and retrieval system and being configured to be stacked in a stack of storage containers such that an underlying storage container supports the storage container(s) positioned above. The storage container is adapted to be lifted by grippers on a lifting device such that the storage container can be lifted from above. The storage container comprises: a base and four sides hingedly connected to an edge of the base. The base and four sides are made from a sheet metal blank. The four sides are hingedly connected to the base by a live hinge. Four corner posts, each configured to interconnect a pair of adjacent sides to each other in a horizontal direction when the sides are positioned substantially 90 degrees relative the base and relative each other. The corner ports function as structural posts taking up the vertical loads supporting storage containers positioned above in a stack. To maintain the lightness of the storage container, the four corner posts are made from a non-metallic material, e.g. plastic material.

WO2022229453 (Ocado Innovation) teaches a storage container for storage of one or more items in a storage and retrieval system comprising a track system comprising a first and second set of horizontal parallel tracks forming a grid pattern comprising a plurality of grid spaces and stacks of storage containers located beneath the track system and wherein each stack occupies a single grid space. The storage container comprises a metallic container body comprising a base portion formed as a single unitary body and having a container bottom wall and upwardly standing base sidewall and end wall parts to define a tray, and a separate upper portion having upper sidewall and end wall parts upwardly extending from and connected to the respective base sidewall and end wall parts to form a box-like structure with an open end for receiving the one or more items within the box-like structure. The tray provides a leak proof base for the storage of grocery or food items, e.g. milk, juices, etc.

However, one of the main criteria in the fabrication of storage containers for use in a storage and retrieval system discussed above is the cost of the storage containers. Considering that a typical storage and retrieval system can hold up to thousands of storage containers, the cost of the storage containers represents a significant cost of the storage and retrieval system. The cost of the storage containers includes the costs to manufacture the storage containers. A storage container is thus required that is relatively low cost to manufacture compared to the storage containers in the art.

### SUMMARY OF THE INVENTION

The present invention has mitigated the above problem by designing a storage container that is more conducive to automation in the manufacturing process. In order to design a storage container that is conducive to automation in the manufacturing process, the storage container according to the present invention can be assembled from a small number of components and therefore, requires a few number of processing steps in the assembly process. More specifically, the present invention provides a storage container for the storage of one or more items in a storage and retrieval system comprising a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling device on the grid framework structure, the plurality of the tracks being arranged such that each of the plurality of storage columns is below a single grid cell, the storage container comprising a metallic container body comprising a bottom wall and sidewalls and end walls arranged in a box-like structure having an open end for receiving the one or more items within the box-like structure,
wherein the metal container body is formed from two sheet metal blanks, each of the two sheet metal blanks comprising a base portion and outwardly extending panel portions, the outwardly extending panel portions of each of the two sheet metal blanks being folded along respective fold lines relative to the base portion forming the sidewalls and end walls, the two sheet metal blanks being arranged such that the base portion of each of the two sheet metal blanks overlap to form a double layered bottom wall and single walled side walls and end walls.

As the bottom wall experiences more impact(s) in comparison to the rest of the storage container as a result of one or more items being loaded into the storage container, the storage container is assembled with a double layered bottom wall. To further reinforce the bottom wall, optionally, the double layered bottom wall defines a volume between the base portions of the first and second sheet metal blanks (i.e. each of the two sheet metal blanks) for accommodating a stiffening panel or stiffener panel. Optionally, a stiffening panel is housed within the volume. To ensure that the stiffening panel does not greatly increase the weight of the storage container, optionally, the stiffening panel comprises foam or a honeycomb material. To ensure a grabber device of a load handling device is correctly guided into engagement with the storage container, optionally, the metal container body comprises an elongated depression at each corner of the metal body, said elongated depression extending along the height of the metal container body and is angled inwardly into the interior of the metal container body to define a guide for receiving a locating pin of the grabber device.

To provide structural support for any vertical loads from one or more storage containers in a stack, optionally, each corner of the metallic container body comprises a plurality of overlapping layers. The plurality of overlapping layers reinforces the corners of the metallic container body for bearing the load from one or more storage containers being placed on top in a stack. Typically, a fully loaded storage container weighs up to 35 kg. For a stack comprising twenty fully loaded storage containers, the lowermost storage container in a stack would have to bear a weight in the region of 700 kg (6,867 Newtons). The overlapping layers at the corners reinforces the storage containers at the corners for bearing the weight of one or more storage containers above in a stack.

To provide overlapping layers at the corners of the storage containers, the panel portion of each of the two sheet metal blanks is formed with at least one connecting flange at opposing edges of the panel portion for fixedly connecting the sidewalls and end walls together at each corner of the box-like structure, the at least one connecting flange being configured to overlap an adjacent connecting flange when a pair of panel portions are brought together to form the sidewalls and end walls.

To enable a grabber device of a load handling device to releasably grip the storage container and to allow the storage containers to be seated on top of each other in a stack so that they can be easily separated when being winched from above, optionally, the metallic container body is formed with a rim portion extending around at least a portion of the periphery of the open end of the box-like structure for supporting the bottom wall of an adjacent storage container above in a stack. Optionally, the rim portion being formed as an inwardly or outwardly turned upper edge of the sidewalls and/or the end walls. Optionally, the rim portion comprises a plurality of openings for receiving the gripper elements of the grabber device. Optionally, each of the plurality of openings is reinforced by an insert.

To enable the panel portions to be easily folded along the fold line, optionally, the fold lines comprise one or more perforations.

The present invention provides a method of fabricating a storage container comprising a metal container body comprising a bottom wall and sidewalls and end walls, the metal container body being formed by the steps of:
i) providing first and second sheet metal blanks, each of the first and second sheet metal blanks comprising a base portion and outwardly extending panel portions, the outwardly extending panel portions of each of the first and second sheet metal blanks being foldable relative to the base portion along a fold line;
ii) laying a first sheet metal blank in a first orientation,
iii) laying a second sheet metal blank on top of the first sheet metal blank in a second orientation, the second orientation being substantially perpendicular to the first orientation such that the base portion of the first sheet metal blank overlaps the base portion of the second sheet metal blank to form a double layered bottom wall;
iv) folding the outwardly extending panel portions of the first sheet metal blank about the fold line to form the side walls;
v) folding the outwardly extending panel portions of the second sheet metal blank about the fold line to form the end walls;
vi) connecting the side walls to the end walls to form a box-like structure having an open end for receiving the one or more items within the box-like structure.

By laying the first sheet metal blank in a first orientation and a second sheet metal blank in a second orientation, where the second orientation is substantially perpendicular to the first orientation lends itself kindly to automation in the fabrication of the storage container. A robot, e.g. robotic arm with a suitable end effector, can simply place the first sheet metal blank in the first orientation and the second sheet metal blank in the second orientation. A second robot or the same robot can simply lift the panel portions hingedly attached to the base portion about their respective fold lines such that the panel portions are brought together to form the sidewalls and end walls of the storage container.

Laying the first sheet metal blank in a first orientation and the second sheet metal blank in a second orientation also lends itself kindly to forming the sidewalls and end walls of the storage container in a single operation. Optionally, the method further comprises the step of applying a force to the overlapping base portions so as to cause the panel portions of the first and second sheet metal blanks to fold upwardly relative to the overlapping base portions to form the sidewalls and end walls of the storage container. For example, applying a pushing force to the overlapping base portions by a plunger through an opening in a tool or die causes the respective panel portions to lift relative to the overlapping base portions, thereby, forming the sidewalls and end walls of the storage container. Optionally, the metallic container body can be formed from aluminium or steel or galvanised steel.

Optionally, the method further comprises the step of laying a stiffening panel between the base portion of first sheet metal blank and the second sheet metal blank such that the stiffening panel is sandwiched in or between the double layered bottom wall. To reinforce the bottom wall of the storage container, the method further comprises the step of sandwiching a stiffener panel between the base portions of the first and second sheet metal blanks.

To join the panel portions of each of the first and second sheet metal blanks to form the sidewalls and end walls of the storage container, the panel portions of each of the first and second sheet metal blanks is formed with a connecting flange extending along opposing edges of the panel portions and foldable along at least one fold line; wherein the method further comprises the step of folding the connecting flange along the at least one fold line to define a connecting surface for connecting the sidewalls and the end walls together.

For the storage containers to be seated one on top of the other in a stack without getting stuck and to enable the grabber device to be seated on the storage container for engagement with the storage container, the method further comprises the step of inwardly or outwardly turning an edge of the sidewalls and end walls about one or more fold lines to form a rim portion extending around at least a portion of the periphery of the open end of the box-like structure. Preferably, the edge is an upper edge.

For the grabber device to properly engage with the storage container, it is necessary that the grabber device properly engages with the rim of the storage container. Typically, the grabber device comprises one or more gripper elements that are received in one or more openings in the rim of the storage container. However, to properly engage with the storage container, it is necessary that the gripper elements properly align into the one or more openings in the rim of the storage container. To help align the grabber device with the rim of the storage container, the at least one fold line of the connecting flange of the first and/or second sheet metal blanks comprises first and second fold lines, the second fold line being parallel to but spaced apart from the first fold line and; wherein the method further comprises the step of folding a first portion of the connecting flange along the first fold line and folding a second portion of the connecting flange along the second fold line such that the first portion of the connecting flange is substantially perpendicular to the second portion of the connecting flange to define an elongated depression when the sidewalls and end walls are brought together to define a guide for receiving a locating pin of a grabber device.

The present invention further provides a storage and retrieval system, comprising
a) a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling device on the grid framework structure, the plurality of the tracks being arranged such that each of the plurality of storage columns is below a single grid cell;
b) a plurality of stacks of storage containers comprising a bottom wall and upwardly standing sidewalls and end walls; each stack of the plurality of storage containers occupying a single storage column of the plurality of storage columns, each storage container of the plurality of stacks of storage containers being formed by the method according to the present invention,
c) a plurality of robotic load handling devices for lifting and moving storage containers stacked in the storage columns, the plurality of load handling devices being remotely operated to move laterally on the track system above the plurality of storage columns to access the storage containers through the grid cells, each of said plurality of robotic load handling devices comprising:
   i) a wheel assembly for guiding the load handling device on the track system;
   ii) a container-receiving space located above the track system; and
   iii) a lifting device arranged to lift a single container from a stack into the container-receiving space.

### BRIEF DESCRIPTION OF THE DRAWINGS

Further features and aspects of the present invention will be apparent from the following detailed description of an illustrative embodiment made with reference to the drawings, in which:

FIG. 1 is an illustration of an automated storage and retrieval system according to an exemplary embodiment of the present invention.

FIG. 2 is a schematic diagram of a top down view showing a stack of bins arranged within the framework structure of FIG. 1.

FIG. 3 is a schematic diagram of a system of a known load handling device operating on the grid framework structure.

FIG. 4 is a schematic perspective view of the load handling device showing the container receiving space within the body of the load handling device.

FIGS. 5A and 5B are schematic perspective cut away views of the load handling device of FIG. 4 showing (a) a container accommodating a container receiving space of the load handling device the container receiving space of the load handling device and (b) the container receiving space of the load handling device a container accommodating the container receiving space of the load handling device.

FIG. 6 is a schematic perspective view of the grabber device positioned above the storage container.

FIG. 7A is a schematic perspective view of the grabber device mounted on the storage container.

FIG. 7B is a schematic perspective view of the grabber device engaging with the storage container.

FIG. 8 is a perspective view of a storage container according to an embodiment of the present invention.

FIG. 9 illustrates the sheet metal blanks used in the construction of the storage container shown in FIG. 8.

FIG. 10 illustrates an arrangement of the sheet metal blanks in the construction of the storage container shown in FIG. 8.

FIG. 11 illustrates a second arrangement of the sheet metal blanks in the construction of the storage container shown in FIG. 8.

FIGS. 12A and 12B are enlarged views of a corner of the storage container showing a depression for guiding the grabber device on the rim portion of the storage container; where (a) shows the offering up of the connecting flanges forming the depression; and (b) shows the cooperation of the connecting flanges at the corner of the storage container.

FIG. 13 is a perspective view of the storage container showing the openings in the rim portion of the storage container for engaging with the storage container according to an embodiment of the present invention.

FIG. 14 is a perspective view of the storage container showing the handles in the end walls of the storage container according to an embodiment of the present invention.

FIG. 15 is a perspective view of the storage container showing a mounting plate to reinforce the engagement holes in the rim portion of the storage container.

FIG. 16 is an enlarged view of the rim portion of the storage container.

FIGS. 17A and 17B are perspective views of the tooling used to form the storage container according to an embodiment of the present invention; where (a) shows the combined sheet metal blanks positioned in the pressing tool; and (b) shows the downward movement of the punch causing the outwardly extending panels being brought together to form the sidewalls and end walls of the storage container.

FIG. 18 is perspective view of a leak proof liner used to line the storage container.

FIG. 19 is a perspective view of the storage container shown in FIG. 8 lined with the liner shown in FIG. 18.

### DETAILED DESCRIPTION

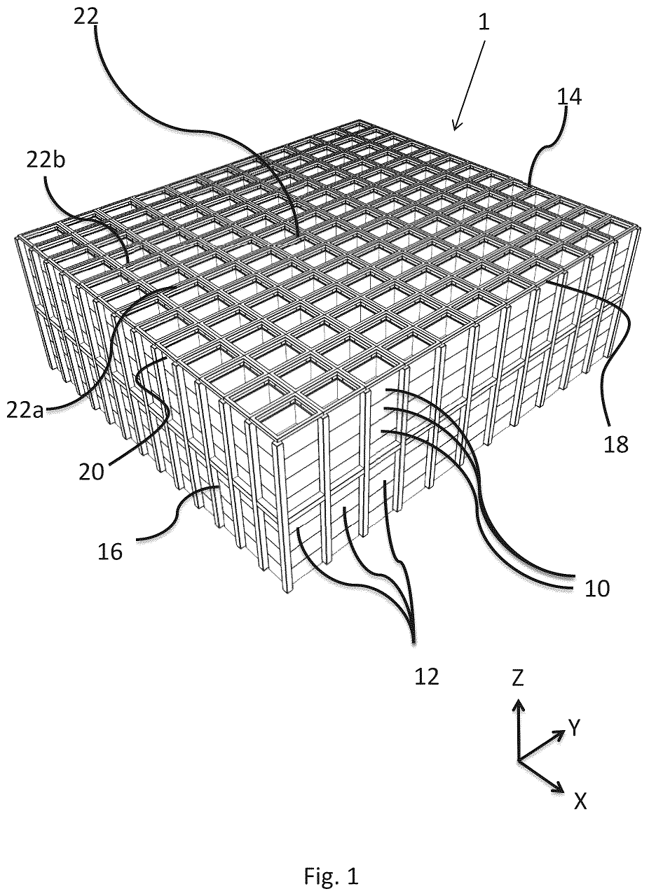

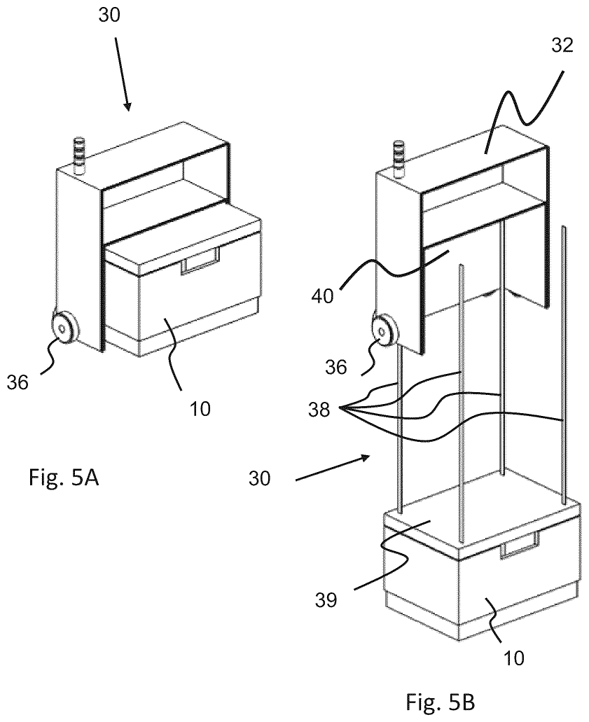

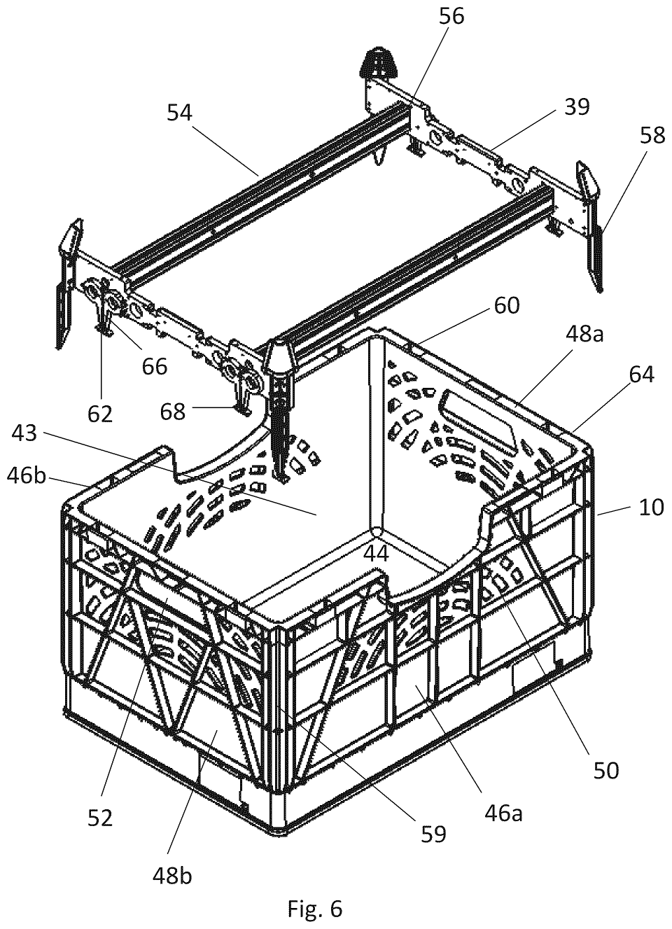

It is against the known features of the storage system such as the grid framework structure and the load handling device described above with reference to FIGS. 1 to 5, that the present invention has been devised. FIG. 6 shows a grabber device 39 positioned above one form of a typical storage container or bin 10 for use within the storage and retrieval system of FIGS. 1 to 3. The storage container or bin 10 comprises a substantially box type structure having an open top 43, a container bottom wall 44, and opposing sidewalls 46 (a and b) and end walls 48 (a and b). In the particular example shown in FIG. 6, the bin 10 has a substantially rectangular shaped container bottom wall 44 such that the length of the opposing sidewalls 46 (a and b) are longer than the length of the opposing end walls 48 (a and b). The opposing sidewalls 46 (a and b) and end walls 48 (a and b) of the bin comprises one or more ribs to reinforce the sidewalls and end walls of the storage container. A plurality of the bins 10 may be stacked in a self-supporting stack 12, a plurality of stacks 12 being disposed within the grid framework structure 14 as described above. In storage facilities of the type described with reference to FIGS. 1 to 3, it will be appreciated that there may be a large number of bins 10, in some cases hundreds or thousands. Typically, each bin 10 must be able to bear the load of multiple bins 10 in a stack. The bin stack load is carried by the maximum load of twenty fully loaded bins. The weight of a fully loaded bin is about 35 kg, of which 5 kg represents the weight of the bin alone. For example, a stack of twenty bins 10 would represent a load of 700 kg or 6,867 N. The one or more ribs on the opposing sidewalls and end walls strengthens the sidewalls and end walls so as to prevent sidewalls and end walls buckling under such a load in a stack.

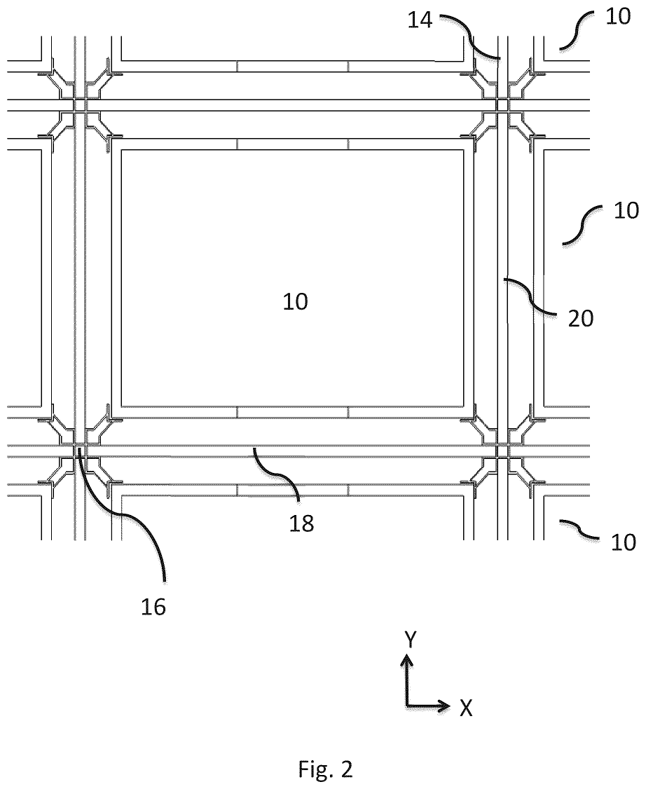

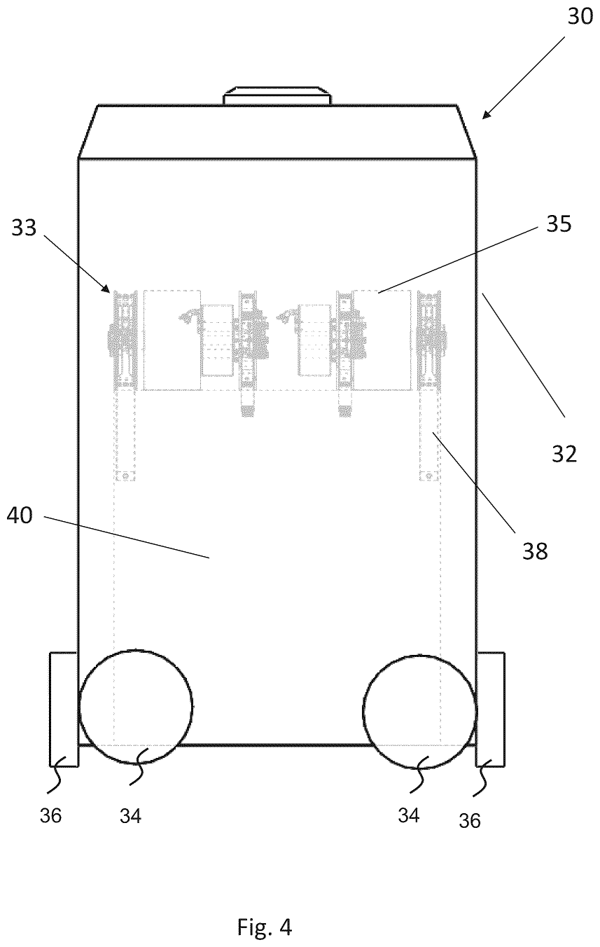

Also shown in FIG. 6 is the grabber device 39, which forms part of the lifting mechanism 33 of the robotic load handling device, positioned above the bin 10. The lifting mechanism 33 used to lift the containers into the container receiving space can take any suitable form and comprises a winch or a crane mechanism (see FIG. 4). The crane mechanism comprises a winch cable 38 wound on a spool or reel and a grabber device 39. The grabber device 39 is configured to grip the top of the container 10 to lift it from a stack of containers in a storage system of the type shown in FIGS. 1 and 2. Typically, the grabber device 39 is configured as a frame 54 and four lifting tethers 38 are fixed to each corner of the grabber device 39 (see FIG. 5B). For maximum stability and load capacity, commonly four lifting tethers 38 are used to winch the grabber device 39, with one tether disposed nearby or at each of the corners of the grabber device 39, but a different arrangement, for example with fewer tethers, could be used if desired. One end, e.g. first end, of each of the tethers is wound on the spool in the load handling device and the other end, e.g. second end, is fixed to the grabber device 39, typically at each corner of the grabber device, by a suitable bracket (not shown). The number of tethers attached to the grabber device is dependent on the ability to maintain the grabber device horizontal during operation when picking up a container 10 and the ability to withstand the tension applied to the tethers when lifting containers, which could weigh up to 40 kg, without extending or stretching, i.e. be inextensible under a predetermined applied tensile stress. To possess the necessary physical properties (Young's Modulus), the tethers are generally in the form of a tape, but other tethers with the necessary physical properties to winch containers are permissible to winch the bin from a stack.

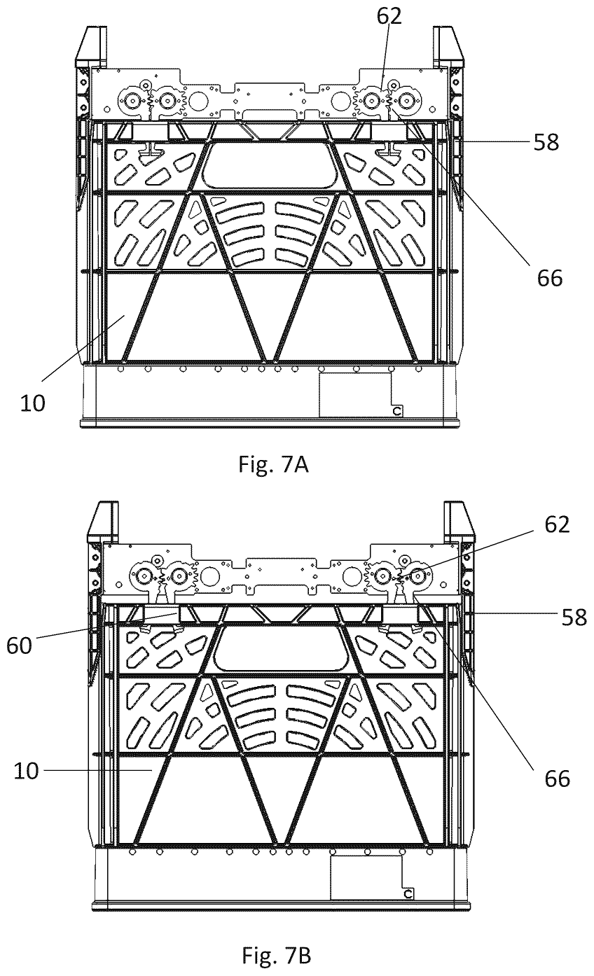

In the example shown in FIG. 6, the frame 54 of the grabber device has four corner sections 56, a top side, and a bottom side. To grab a container 10, the grabber device 39 comprises four gripper elements 62 arranged at the bottom side of the grabber device 39 to engage with corresponding holes or openings 60 in the rim 64 of the bin 10 (see FIG. 7A). To help the grabber device 39 to properly align the gripper elements 62 with corresponding holes or openings 60 in the rim 64 of the storage container, the grabber device 39 further comprises locating pins 58 downwardly extending from the frame 54 of the grabber device and configured to engage with one or more depressions 59 formed at one or more corners of the storage container. The one or more depressions 59 at the corners of the storage container function to guide the grabber device 39 into engagement with the rim of the storage container. In the particular embodiment of the present invention shown in FIG. 6, a depression 59 is formed at each of the four corners of the storage container for guiding the grabber device 39 via the locating pins 58 into engagement with the rim of the storage container.

In the example shown in FIG. 7A, each of the gripper elements 62 comprises a pair of wings 66 that are collapsible to be receivable in corresponding holes 60 in the rim 64 of the container and an open enlarged configuration having a size greater than the holes 62 in the rim 64 of the container 10 in at least one dimension so as to lock onto the container 10 (see FIG. 7B). The wings are driven into the open configuration by a drive gear (not shown). More specifically, the head of at least one of the wings comprises a plurality of teeth that mesh with the drive gear such that when the gripper elements 62 are actuated, rotation of the drive gear causes the pair of wings to rotate from a collapsed configuration (FIG. 7A) to an open enlarged configuration (FIG. 7B).

When in the collapsed or closed configuration, the gripper elements 62 are sized to be receivable in corresponding holes 60 in the rim 64 of the container 10 as shown in FIG. 7A. The foot of each of the pair of wings comprises a stop 68 (see FIG. 6), e.g. a boss, such that when received in a corresponding hole 60 in the rim 64 of the container 10, the stop 68 engages with an underside of the rim 64 when in an enlarged open configuration to lock onto the container when the grabber device 39 is winched upwards towards the container-receiving space of the load handling device. FIG. 7B shows the configuration of the gripper elements in an enlarged configuration for lifting the bin 10 into the container receiving space of the robotic load handling device.

The gripper elements 64 are received in the holes 60 in the rim 64 of the container 10 when the grabber device 39 is at a predetermined height above the rim of the container as measured by one or more depth sensors (not shown) mounted to the underside of the grabber device. At this depth, the gripper elements 64 are actuated to grab the bin 10 in response from a signal from the one or more of the depth sensors (not shown) mounted to the underside of the grabber device 39. Also shown in FIGS. 6 to 7B is a handle 52 in the form of an opening in the end walls of the storage container.

Typically, the bins 10 are largely composed of a thermoplastic material and are either injected moulded or blow moulded. Known thermoplastic material commonly used in the moulding of the storage containers comprises a polyolefin, e.g. polypropylene or polyethylene, (e.g. high density polyethylene (HDPE)), acrylonitrile butadiene styrene (ABS) and polycarbonate including copolymers thereof. However, the problem with such plastic materials is that they are flammable and emit toxic fumes. Once a fire has started within the storage and retrieval system, the flammable and exothermic nature of the material of the bins 10 would result in the fire spreading throughout the storage and retrieval system with a danger to life. Not only are the bins 10 flammable but the combustion fumes emitted from the burning thermoplastic material are highly toxic comprising benzene, which is a known carcinogen. Inhalation of fine particles as a result of the burning debris may cause respiratory irritation. As a result, extreme fire precaution methods and systems are incorporated into the storage and retrieval system to prevent the rapid spread of fire, such as sprinklers and smoke/heat detection units. Whilst efforts have been made to prevent the rapid spread of fire, of which the bins 10, play a major role in the spread of the fire, there is still the problem of fire spreading throughout the storage and retrieval system.

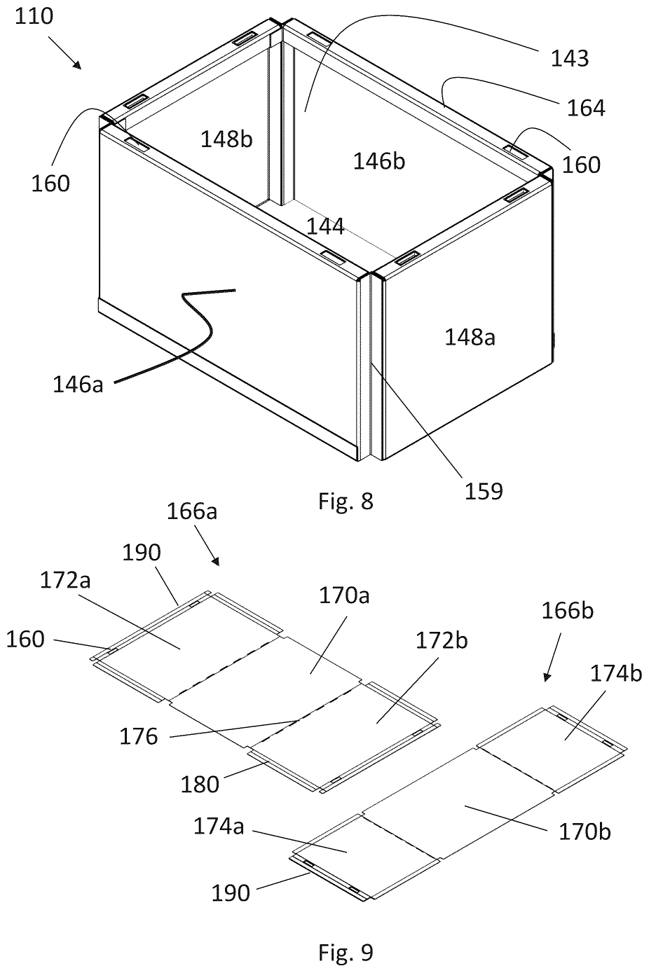

The present invention has mitigated the above problem by providing a storage container 110 comprising a metallic container body comprising a container bottom wall 144 and opposing sidewalls 146(a and b) and opposing end walls 148(a and b). In the examples of the different types of storage containers discussed below with reference to FIGS. 8 to 17B, the entirety of the storage container is formed from the metallic container body in the sense that the metallic container body is the storage container. However, the storage container of the present invention is not limited to being entirely formed from a metallic container body and at least a portion of the storage container can comprise other materials, e.g. plastic material. For example, the metallic container body can form a metallic lining of the storage container. The storage container comprising the metallic container body is also applicable to delivery containers, DT, in the sense that the delivery container can also comprise a metallic container body of the present invention comprising a container bottom wall and opposing sidewalls and opposing end walls.

The storage container 110 can be fabricated from stainless steel sheet metal having a thickness in the range 0.5 mm to 2.0 mm, for example the thickness may be 0.55 mm, 0.6 mm, 0.7 mm, 0.8 mm, 0.9 mm and 1 mm. However, other metals can be used in the fabrication of the metallic container body including but not limited to aluminium. To provide the necessary structural rigidity of the walls of the storage container, preferably the thickness of the sheet metal blank is about 2 mm. These include various stainless steel materials such as 304 stainless steel.

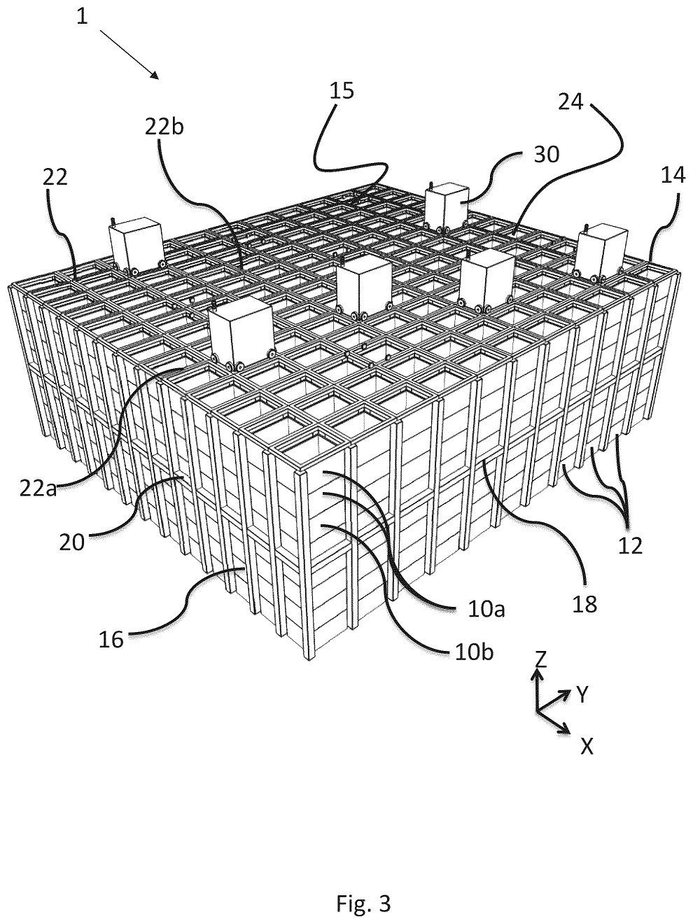

The storage containers described below with reference to FIG. 8 to 17B) relate to the storage container being formed from a metallic container body. For ease of explanation, the metallic container body in the forthcoming examples can be referred to as storage containers. The metallic container body of the present invention can have a similar shape to the storage containers currently in existence for the storage of items in the grid framework structure described above, e.g. having a substantially rectangular container bottom wall and opposing side walls and end walls. The metallic storage containers can be used amongst the traditional plastic storage containers in the storage and retrieval systems described above with reference to FIG. 3. The flame resistant behaviour of the metallic storage containers can be used to form a flame resistant barrier wall in the grid framework structure. For example, a plurality of stacks of metallic storage containers can be arranged to form one or more flame resistant barrier walls surrounding the plurality of stacks of plastic storage containers. One or more flame resistant barrier walls comprising the metallic storage containers can be used to contain any flames within the grid framework structure.

Key features of the storage container for use in an automated storage and retrieval system is the weight of the storage container in order to be hoisted by a robotic load handling device operable on the grid framework structure and having sufficient structural rigidity to withstand loads being applied to them when placed in a stack. Ideally, the weight of the storage containers should be below 8 kg, preferably below 6 kg, more preferably below 5 kg. Considering that a fully loaded storage container can weigh as much as 35 kg, this amounts to a weight of 700 kg for a stack of twenty storage containers. There are numerous methods discussed in the art to fabricate the storage containers comprising a metallic container body. However, such methods require a complex arrangement and/or assembly of the walls of the storage container requiring multiple processing steps that may not be conducive to complete automation. Considering that there are hundreds or even thousands of storage containers in storage in a typical storage and retrieval system, a storage container comprising a metal container body is thus required that can be easily manufactured requiring fewer components and a fewer number of processing steps than the metal storage containers in the prior art so that it can easily be automated at lower cost.

An example of the storage container 110 formed with a metallic container body according to the present invention is shown in FIG. 8. Like the storage container currently used in practice, the storage container comprises a bottom wall 144 and upwardly standing sidewalls 146(a and b) and end walls 148(a and b) arranged to form a box-like structure with an open end 143 for receiving one or more items. A rim portion 164 is arranged in the upper edge of the storage container that is configured to engage with the grabber device 39 discussed above. As shown in FIG. 8, the rim portion 164 comprises one or more openings or holes 160 for receiving the gripper elements of the grabber device. Also shown in FIG. 8, are elongated depressions 159 at the corners being formed along the full height of the storage container. The elongated depressions 159 extend into the interior of the storage container to define a guide surface for receiving the location pin 58 of the grabber device. As discussed above, the elongated depressions 159 help to align the gripper elements into engagement with the plurality of openings 160 in the rim portion 164 of the storage container. However, it is not essential for the elongated depressions 159 to extend along the full height of the storage container. The elongated depressions 159 can extend from the rim portion along at least a portion of the height of the storage container so as to allow the grabber device to engage with the rim of the storage container by being guided by the locating pins of the grabber device along the elongated depressions.

To create a storage container comprising a metal container body exhibiting the characteristics of low cost and being formed from a fewer number of processing steps, the following method steps will be described below.

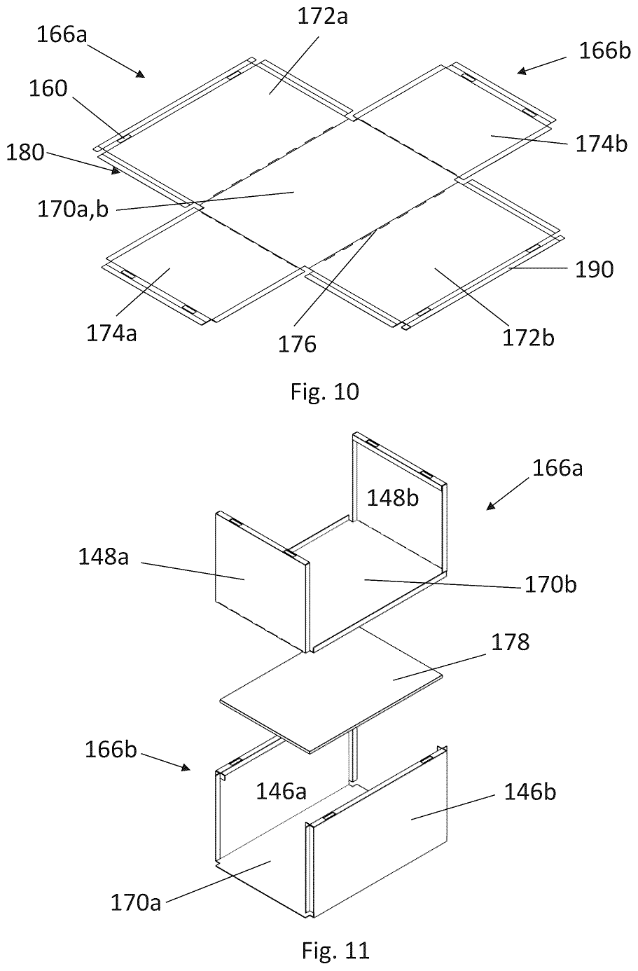

In the particular example of the present invention, the storage container 110 is formed from two sheet metal blanks 166a, 166b arranged in a criss-cross fashion so that at least a portion of the two sheet metal blanks overlap 166a, 166b (see FIGS. 9 and 10). Each of the two metal blanks 166a, 166b comprise a base portion 170(a and b) and two panel portions 172(a and b), 174(a and b) outwardly extending from their respective base portions 170(a and b). Each of the panel portions are hingedly attached to the base portion by a fold line 176 so as to enable the panel portions 172(a and b), 174(a and b) to be foldable relative to the base portion 170(a and b). To enable the panel portions 172(a and b), 174(a and b) to be easily folded relative to the base portion 170(a and b), the fold line 176 can have one or more perforations. The two sheet metal blanks 166(a and b) can comprise a first sheet metal blank 166a and a second sheet metal blank 166b. The first sheet metal blank 166a comprises a base portion 170a and a first pair of panel portions 172(a and b) extending outwardly from the base portion 170a foldable along their respective fold lines 176 to form the upwardly standing sidewalls 146(a and b) of the storage container. The second sheet metal blank 166b comprises a base portion 170b and a second pair of panel portions 174(a and b) extending outwardly from the base portion 170b foldable along their respective fold lines 176 to form the upwardly standing end walls 148(a and b) of the storage container.

In one example of forming the storage container, the two sheet metal blanks 166a, 166b can be arranged in a cross shaped arrangement so that the base portions 170(a and b) of each of the two sheet metal blanks overlap, i.e. the two sheet metal blanks are arranged substantially perpendicular to each other (see FIG. 10). This allows the panel portions 166a, 166b to form the sidewalls 146(a and b) and end walls 148(a and b) of the storage container when the panel portions 172(a and b), 174(a and b) are lifted relative to the base portion about its fold line 176 so that their free edges connect as shown in FIG. 8. Alternatively, the panel portions of each of the two sheet metal blanks are lifted or folded to form two U shaped parts prior to being assembled together to form the storage container as shown in FIG. 11. Each of the two U shaped parts are arranged substantially perpendicular to each other so their folded panel portions respectively form the sidewalls and end walls of the storage container when they are assembled together. In both cases, the base portions 170(a and b) of the first and second sheet metal blanks overlap to form a doubled layered bottom wall. The double layered bottom wall reinforces the bottom wall from any impact from one or more items being loaded into the storage container. To further strengthen the bottom wall of the storage container, the overlapping base portions of the first and second sheet metal blanks define a volume for incorporating a stiffening panel 178 as shown in FIG. 11. The stiffening panel 178 can be a lightweight structural material such as having a foam or honeycomb structure comprising plastic or metal. Such structural foam or honeycomb material is lightweight, rigid, and durable compared to solid parts. Examples of structural materials include but is not limited to polycarbonate (PC), acrylonitrile-butadiene-styrene (ABS), polystyrene (PS), polypropylene (PP) and polyvinyl chloride (PVC).

To join or connect the sidewalls and end walls together to form a box-like structure, the panel portions are formed with flanges 180 that extend along their opposing edges. The flanges 180 overlap when the sidewalls and end walls are brought together. For example, a flange of the panel portions forming the sidewalls and end walls are configured to overlap when the panel portions are brought together. Not only does overlapping layers at the corners of the storage container enable the sidewalls and end walls to be connected together but also increases the structural integrity of the metallic container body for bearing the weight of multiple storage containers in a stack. Each of the flanges of an adjacent sidewall or end wall extends along the height of the metallic container body. Various fasteners known in the art can be used to fix the sidewalls and end walls together at the corners of the metallic container body using their respective flanges. These include but are not limited to welding, e.g. spot welding, riveting, and/or use of an adhesive.

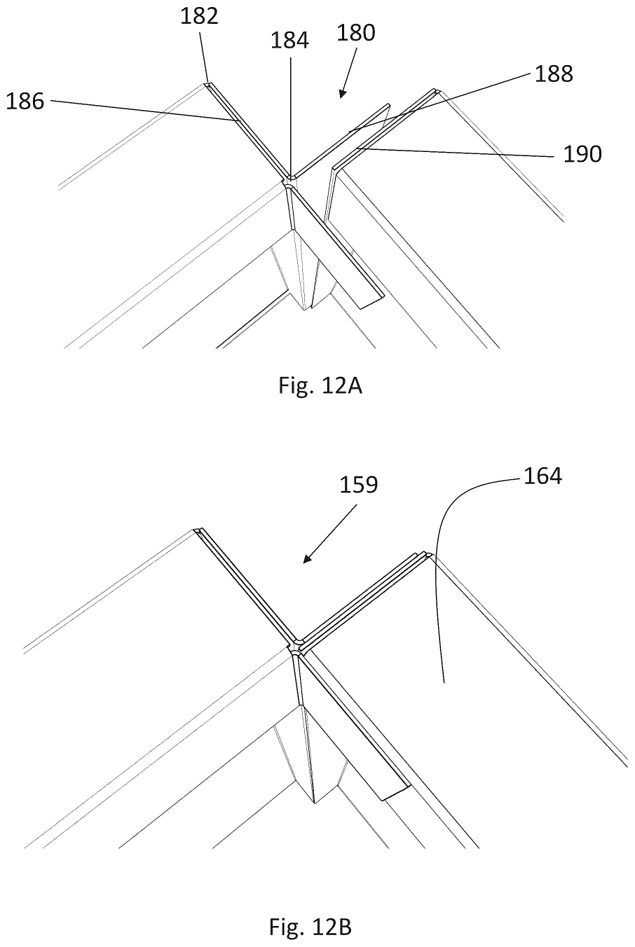

To enable the gripper elements of the grabber device to properly align with the apertures or openings 160 in the rim portion 164 of the storage container, the metallic container body comprises a guide 159 at each of the corners of the box-like structure of the metallic container body that extends vertically at least partially along the height of the box-like structure for accommodating the guiding pins or locating pins of the grabber device. As discussed above with reference to FIG. 6, the guides 159 are shaped to cooperate with the guiding pins or location pins of the grabber device so as to properly align the gripper elements 62 with the openings 160 in the rim portion 164 of the storage container. The guides 159 at the corners of the metallic container body are shown as elongated vertical depressions formed by one or more bends in the flanges 180 of the panel portions forming the sidewalls and/or end walls of the metal container body. To form an elongated depression at each corner of the storage container, at least one edge of the panel portions of at least one of the sheet metal blanks is formed with a flange having at least two fold lines 182, 184. The at least two fold lines are spaced apart and parallel so as to enable the flange of the first sheet metal blank to be folded to form first and second flange portions 186, 188 that are angled perpendicular to each other such that when connected or fixed to adjacent flange 190 of the second sheet metal blank an elongated depression 159 results (see FIGS. 12A and 12B).

Similarly to the elongated depression, the rim potion 164 extending around at least a portion of the periphery of the open end of the box-like structure of the storage container is formed by inwardly or outwardly turning an upper edge of the sidewalls and end walls along at least two fold lines. To form the rim portion, an edge of each of the panel portions forming the upper edge of the sidewalls and end walls of the storage container is formed with a flange 190 foldable along at least two fold lines. As with the elongated depression, the at least two fold lines are spaced apart and parallel. In the particular embodiment of the present invention, the flange 190 at the upper edge of the sidewalls and end walls is formed with three fold lines so enabling the flange to be inwardly or outwardly turned to form a tubular structure that is better at resisting loads than non-tubular structures. This is important, as the storage containers should be able to be picked up or lowered via engagement with the rim portion of the storage container and be able to be stacked in the grid framework structure. To incorporate the openings in the rim portion for the gripper elements of the grabber device to engage with the storage container, the flange 190 forming the rim portion comprise one or more openings 160 such that when the flange 190 is folded along their respective fold lines, one or more openings are disposed in the upper surface of the rim portion and are presented to the grabber device.

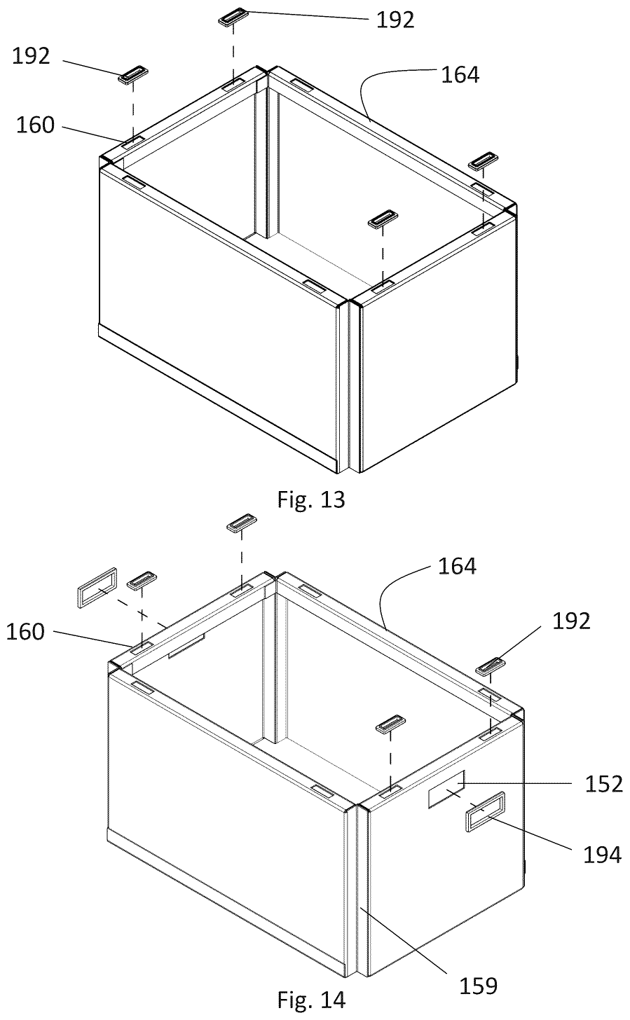

As the gripper elements are constantly engaging with the rim portion of the storage container, the one or more openings 160 in the rim portion can be reinforced by one or more inserts 192 mounted onto the openings 160, e.g. by a snap fit connection, so as to reinforce the peripheral edges of the openings as shown in FIGS. 13 and 14. In the particular embodiment shown in FIGS. 13 and 14, separate inserts are mounted to the one or more openings 160 in the rim portion 164. The one or more openings 160 shown in FIGS. 13 and 14 comprise a first pair of openings for engaging with a first pair of gripper elements and a second pair of openings for engaging with a second pair of gripper elements, i.e. a total of four gripper elements. In FIG. 14, one or more openings are shown in the sidewalls or end walls of the storage container that are shaped to form lifting handles 152. Like the openings 160 in the rim portion, each of the openings in the sidewalls or end walls forming the handles for manually picking up the storage container can be reinforced by an insert 196.

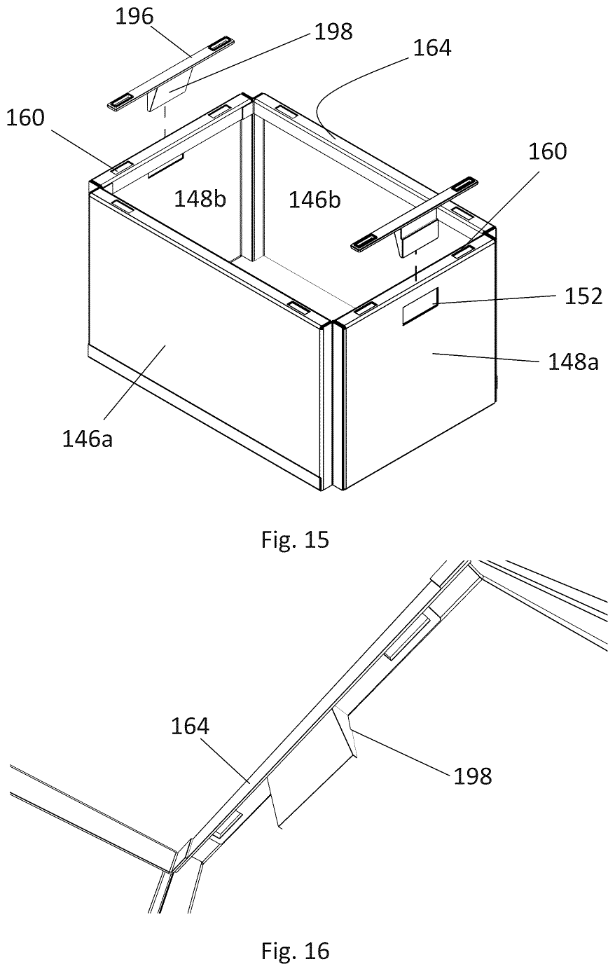

Alternatively and as shown in FIG. 15, a pair of inserts can be formed as a mounting plate 196 that is mounted to each pair of the first and second pair of openings in the rim portion of the storage container. Also shown in FIG. 15, are the one or more openings in the sidewalls or end walls of the storage container forming the lifting handles 152 of the storage container. The mounting plate can additionally comprise handle covers 198 downwardly extending from the pair of inserts and configured to engage with the opening of the handle in a snap fit arrangement (see FIG. 16). The downwardly extending handle covers 198 provides further structural rigidity to the rim portion 164 of the storage container.

The sheet metal blanks can be stamped to the required shape and dimension by a sheet metal stamping die or tool. Assembly of the storage container involves orientating the first sheet metal blank 166a in a first orientation and a second sheet metal blank 166b in a second orientation, the second orientation being substantially perpendicular to the first orientation such that the combined first and second sheet metal blanks adopts a cross shaped configuration and the base portions of the first and second sheet metal blanks overlap. The sidewalls and end walls of the storage container is formed by simply lifting the outwardly extending panel portions 172(a and b), 174(a and b) and subsequently fixing or connecting the sidewalls and end walls together by their respective flanges 180 as discussed above. The step of forming the rim portion by inwardly or outwardly turning the edge of the panel portions forming the upper edge of the sidewalls and the end walls can be carried out before the panel portions are brought together in a box-like configuration or subsequent to the panel portions being brought together.

The steps in the manufacture of the storage container can be summarised as follows:
i) laying first and second sheet metal blanks in a cross shaped configuration such that their respective base portions overlap;
ii) inserting a stiffening panel between the base portions of the first and second sheet metal blanks;
iii) lifting the panel portions to form the sidewalls and end walls;
iv) joining the sidewalls and end walls together;
v) inwardly or outwardly turning the upper edge of the sidewall and end wall to form the rim portion.

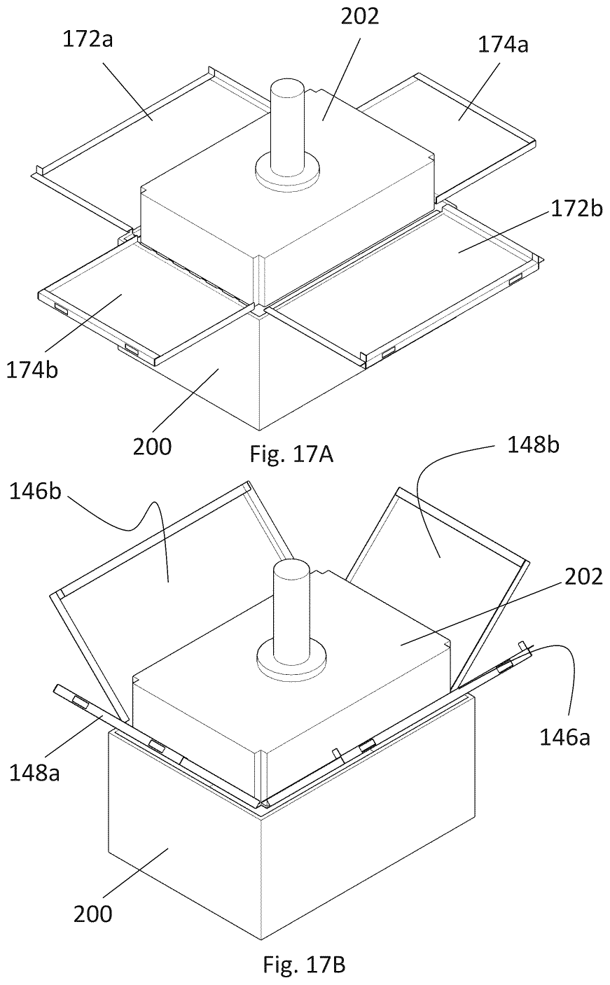

Steps (i) to (v) can be fully or partially automated. The step of inserting the stiffening panel in Step (ii) can be optional. One or more robotic arms with suitable end effectors can be instructed to perform all or some of the steps of assembling the storage container. A suitable press comprising a die 200 with a well having a cross section corresponding to shape and size of the base portion and a punch 202 can be used to lift the panel portions forming the sidewalls and end walls as shown in FIGS. 17A and 17B. As the storage container is substantially cuboidal having a substantially rectangular base portion, the cross section of the well is substantially rectangular. The sheet metal blanks can be placed on the die 200 such that their overlapping base portions is positioned above the opening of the well in the die 200. A stamp or punch 202 is used to apply pressure to the overlapping base portions to cause the outwardly extending panel portions to lift relative to the overlapping base portions as shown in FIG. 17B. Further movement of the punch 202 into the well causes the panel portions to be brought closer together forming the sidewalls 146(a and b) and end walls 148(a and b)of the formed storage container. A robotic arm with suitable end effector can be used to fix the sidewalls and end walls together, e.g. welding, riveting, etc. The step of lifting the panels portions 172(a and b), 174(a and b) to form the sidewalls 146(a and b) and end walls 148(a and b) of the storage container can be carried out in a single pressing operation.

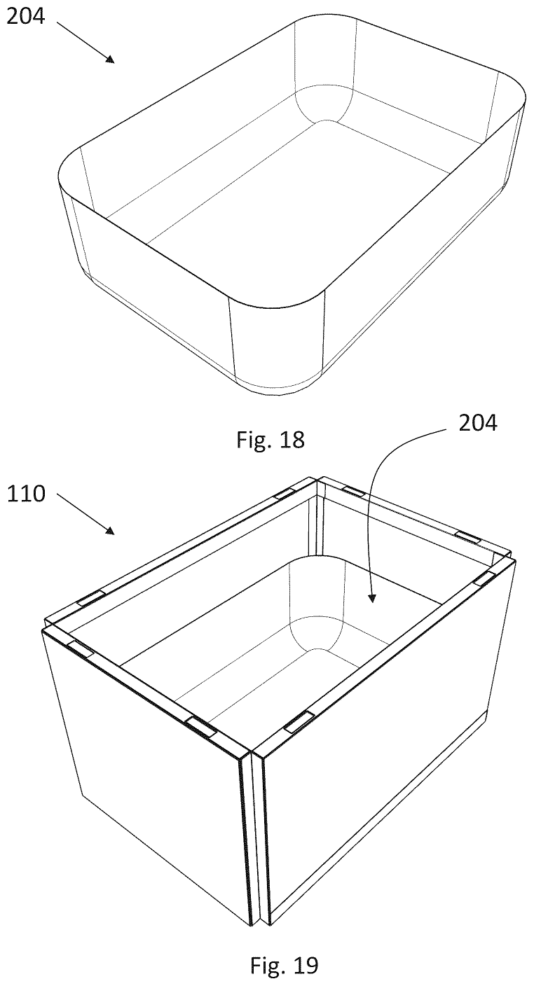

The storage container 110 can optionally be lined with a liner 204 as shown in FIGS. 18 and 19. For example, the liner 204 can comprise a food grade plastic material and/or cellulose base material which may be coated or impregnated with a wax material. To prevent leakage of juices from food items from the storage container contaminating food items in a storage container below in a stack, preferably, the liner is a leak proof container. Optionally, the leak proof container is a one piece thermoformed container, e.g. by a blow moulding or a deep drawn moulding process. The liner 204 can simply be inserted into the storage container to convert the storage container into a leak proof storage container. In the particular embodiment shown in FIG. 19, the height of the liner 204 does not extend the full height of the storage container but rather extends at least a portion of the height of the storage container. However, there is no limitation to the liner extending the full height of the storage container. In addition to providing a leak proof storage container, the use of a liner provides additional benefits in the manufacture of the metal container body. For example, a lower grade steel such as galvanised steel can be used in the manufacture of the metal container body. Galvanised steel offers the advantage of being more ductile than stainless steel and therefore, is easily formable into a desired shape. In this case, the bending the two sheet metal blanks along the fold lines and forming elongated vertical depressions at the corners of the storage container by one or more bends in the connecting flanges.

Whilst the preferred embodiments of the present invention have been described in detail above, it should be understood that various modifications of the storage container encompassing different features described above, and different combinations of features described in relation to different embodiments, are applicable within the scope of the present invention as defined in the claims.

1. A storage container for the storage of one or more items in a storage and retrieval system comprising a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling device on the grid framework structure, the plurality of the tracks being arranged such that each of the plurality of storage columns is below a single grid cell, the storage container comprising a metallic container body comprising a bottom wall and sidewalls and end walls arranged in a box-like structure having an open end for receiving the one or more items within the box-like structure,
wherein the metal container body is formed from two sheet metal blanks, each of the two sheet metal blanks comprising a base portion and outwardly extending panel portions, the outwardly extending panel portions of each of the two sheet metal blanks being folded along respective fold lines relative to the base portion forming the sidewalls and end walls, the two sheet metal blanks being arranged such that the base portion of each of the two sheet metal blanks overlap to form a double layered bottom wall and single walled side walls and end walls.

2. The storage container of claim 1, wherein the double layered bottom wall defines a volume between the base portions of each of the two sheet metal blanks for accommodating a stiffening panel.

3. The storage container of claim 2, further comprising a stiffening panel housed within the volume.

4. The storage container of claim 3, wherein the stiffening panel comprises foam or a honeycomb material.

5. The storage container of claim 1, wherein the metal container body comprises an elongated depression at each corner of the metal body, said elongated depression extending along the height of the metal container body and is angled inwardly into the interior of the metal container body to define a guide for receiving a locating pin of the grabber device.

6. The storage container of claim 1, wherein each corner of the metallic container body comprises a plurality of overlapping layers.

7. The storage container of claim 6, wherein the panel portion of each of the two sheet metal blanks is formed with at least one connecting flange at opposing edges of the panel portion for fixedly connecting the sidewalls and end walls together at each corner of the box-like structure, the at least one connecting flange being configured to overlap an adjacent connecting flange when a pair of panel portions are brought together to form the sidewalls and end walls.

8. The storage container of claim 1, wherein the metallic container body is formed with a rim portion extending around at least a portion of the periphery of the open end of the box-like structure for supporting the bottom wall of an adjacent storage container above in a stack.

9. The storage container of claim 8, wherein the rim portion being formed as an inwardly or outwardly turned upper edge of the sidewalls and/or the end walls.

10. The storage container of claim 9, wherein the rim portion comprises a plurality of openings for receiving the gripper elements of the grabber device.

11. The storage container of claim 10, wherein each of the plurality of openings is reinforced by an insert.

12. The storage container of claim 1, wherein the fold lines comprises one or more perforations.

13. A method of fabricating a storage container comprising a metal container body comprising a bottom wall and sidewalls and end walls, the metal container body being formed by the steps of:
i) providing first and second sheet metal blanks, each of the first and second sheet metal blanks comprising a base portion and outwardly extending panel portions, the outwardly extending panel portions of each of the first and second sheet metal blanks being foldable relative to the base portion about a fold line;
ii) laying a first sheet metal blank in a first orientation,
iii) laying a second sheet metal blank on top of the first sheet metal blank in a second orientation, the second orientation being substantially perpendicular to the first orientation such that the base portion of the first sheet metal blank overlaps the base portion of the second sheet metal blank to form a double layered bottom wall;
iv) folding the outwardly extending panel portions of the first sheet metal blank about the fold line to form the sidewalls;
v) folding the outwardly extending panel portions of the second sheet metal blank about the fold line to form the end walls; and
vi) connecting the side panels to the end panels to form a box-like structure having an open end for receiving the one or more items within the box-like structure.

14. The method of claim 13, further comprising the step of laying a stiffening panel between the base portion of first sheet metal blank and the second sheet metal blank such that the stiffening panel is sandwiched between the double layered bottom wall.

15. The method of claim 13, further comprising the step of inwardly or outwardly turning an edge of the sidewalls and end walls about one or more fold lines to form a rim portion extending around at least a portion of the periphery of the open end of the box-like structure.

16. The method of claim 13, further comprising the step of sandwiching a stiffener panel between the base portions of the first and second sheet metal blanks.

17. The method of claim 13, wherein the panel portions of each of the first and second sheet metal blanks is formed with a connecting flange extending along opposing edges of the panel portions and foldable along at least one fold line; wherein the method further comprising the step of folding the connecting flange along the at least one fold line to define a connecting surface for connecting the sidewalls and the end walls together.

18. The method of claim 17, wherein the at least one fold line of the connecting flange of the first and/or second sheet metal blanks comprises first and second fold lines, the second fold line being parallel to but spaced apart from the first fold line and; wherein the method further comprises the step of folding a first portion of the connecting flange along the first fold line and folding a second portion of the connecting flange along the second fold line such that the first portion of the connecting flange is substantially perpendicular to the second portion of the connecting flange to define an elongated depression when the sidewalls and end walls are brought together to define a guide for receiving a locating pin of a grabber device.

19. The method of claim 13, further comprising the step of applying a force to the overlapping base portions so as to cause the panel portions of the first and second sheet metal blanks to fold upwardly relative to the overlapping base portions to form the sidewalls and end walls of the storage container.

20. A storage and retrieval system, comprising
a) a grid framework structure comprising a plurality of storage columns for the storage of a plurality of stacks of storage containers, a track system comprising a plurality of tracks arranged in a grid pattern comprising a plurality of grid cells arranged above the plurality of storage columns for guiding one or more robotic load handling device on the grid framework structure, the plurality of the tracks being arranged such that each of the plurality of storage columns is below a single grid cell;
b) a plurality of stacks of storage containers comprising a bottom wall and upwardly standing sidewalls and end walls; each stack of the plurality of storage containers occupying a single storage column of the plurality of storage columns, each storage container of the plurality of stacks of storage containers being formed by the method as defined in claim 13,
c) a plurality of robotic load handling devices for lifting and moving storage containers stacked in the storage columns, the plurality of load handling devices being remotely operated to move laterally on the track system above the plurality of storage columns to access the storage containers through the grid cells, each of said plurality of robotic load handling devices comprising:
i) a wheel assembly for guiding the load handling device on the track system;
ii) a container-receiving space located above the track system; and
iii) a lifting device arranged to lift a single container from a stack into the container-receiving space.
